(19) United States
(12) Patent Application Publication
(10) Pub. No.: US 2008/0267006 A1
(43) Pub. Date: Oct. 30, 2008

(54) Device for Mixing Fluids

(76) Inventor: Carlos Miguel Moreira Campos, Porto (PT)

Correspondence Address: SUGHRUE MION, PLLC, 2100 PENNSYLVANIA AVENUE, N.W., SUITE 800, WASHINGTON, DC, 20037, US

(21) Appl. No.: 11/659,476

(22) PCT Filed: Aug. 6, 2004
(86) PCT No.: PCT/PT04/00022

§ 371 Date: Jun. 2, 2008

(51) Int. Cl. B01F 5/04; B01F 3/08

(52) U.S. Cl. 366/165.1; 366/178.1; 366/176.1; 137/890

(57) ABSTRACT

The present invention relates to a device for mixing fluids. It is a hydraulic or pneumatic apparatus, depending on the fluid used for transportation. It is static and has the characteristics of both an extractor and a fluid mixer. Extraction is effected by dragging the suction elements, by means of the circulation of a transporting fluid injected at low pressure. The injection inlets (5 or 6) and suction inlets (6 or 5) are interchangeable and lead to a single outlet (3). The injection tube (1) formed by a helical spiral on the outside surrounded by the sheath (4) increases the pressure in the transporting fluid and creates outward helical movement with centrifugal force in all the fluid that circulates on the outside.

### SCOPE OF THE INVENTION

The device for mixing fluids of the invention is a static apparatus with characteristics similar to those that constitute the natural phenomenon of the hurricane, i.e. differences in pressure and centrifugal and centripetal forces. Depending on the transporting fluid used, the extractor is hydraulic or pneumatic and has the characteristics of both an extractor and a fluid mixer.

Extraction is effected by dragging the suction elements (for example air), by means of the circulation of a transporting fluid (for example water) injected at low pressure, greater than 1 bar, with centrifugal and centripetal force and with compression and decompression.

These characteristics make the extractor original, as well as the technical applications.

### PRIOR ART

Various fluid mixers are known in prior art, of which we wish to mention hereunder those that constitute the subject matter of the patents or patent applications WO 03013712, WO 0200334, U.S. Pat. No. 6,044,910, U.S. Pat. No. 5,051,213 and EP 0 157 696.

Document WO 03013712 relates to a device for mixing fluids, especially a gas injection valve, a nozzle valve, a mixing valve or a jet compressor. A first fluid guiding device is provided in order to guide a first fluid and a second fluid guiding device is provided in order to guide a second fluid. The fluids are mixed with each other in a mixing area which is connected to said fluid guiding device. At least one of the fluid guiding devices is provided with a means for producing turbulence in the related fluid, and a heating device which is associated with the said means for producing turbulence and which in relation to the direction of flow of said fluid is disposed downstream therefrom. The inventive device is especially used to mix hydrogen and saturated water vapour and is used to feed said mixture to a fuel cell.

Document WO 0200334 relates to a method for mixing fluids where a turbulent contactor is used to absorb a selected gas component from a gas stream. The invention particularly applies to a method of distributing a liquid into a gas stream which comprises providing a liquid to an annulus at the periphery of a pipe in which a gas stream is flowing, the gas flow drawing the liquid into a film along the inner surface of the pipe to a sharp edge at the end of the pipe at which point the liquid breaks off the surface of the pipe and mixes intimately with the gas.

U.S. Pat. No. 6,044,910 relates to a mixing device for fluids which introduces CO₂ into a preferably liquid extinguishing medium and includes a housing with a feed line for extinguishing fluid, a feed pipe for CO₂, provided with a metering valve, as well as an outlet line. The CO₂ circulates inside the feed pipe in the opposite flow direction to the extinguishing fluid; the length of the feed pipe between the metering valve and the fluid injection device is dimensioned such that during operation with the metering valve closed a gas cushion forms on its downstream side.

U.S. Pat. No. 5,051,213 relates to a method and apparatus which are used to mix two fluids, two gases, or a fluid and a gas. The preferred embodiment is useful primarily for the aeration of water but can be used to mix any gas with a liquid. The method involves creating relative movement between an elongate element and a fluid whereby a low-pressure area will be developed on the lee side of the element. The gas is then admitted to the low-pressure area and bubbles are formed. The element is preferably pointed to form a tine, and the bubbles are moved along the tine by a component of the relative motion toward the tip.

Finally, patent EP 0 157 696 relates to an apparatus for the rapid “in-line” mixing of two fluids: a primary fluid A and a fluid B, characterised in that it comprises at least one nozzle for injecting a secondary fluid constituted by a mixture (kA+B) of a fraction (k) of primary fluid A and of fluid B, or simply by fluid B, this nozzle being positioned within the conduit inside which the primary fluid A flows and provided with a diaphragm positioned and dimensioned in such a way that at the outlet of the nozzle a radially oriented fluid current is created, thereby rapidly mixing the two fluids within a very small zone.

The subject matter of the present invention is totally different from the mixers of prior art, namely those mentioned above.

In fact, none of the devices mentioned allow the transporting fluid to be injected through one tube connected to the inside of the injection tube and through another tube connected to the outside of the injection tube. This possibility allows the device of the invention to be used as a gas extraction element or simply as a mixer. None of the documents cited offer this possibility.

### BRIEF DESCRIPTION OF THE DRAWINGS

The description given hereunder is based on the drawings attached hereto which, without any restrictive character, schematically represent the two embodiments of the apparatus of the invention, whereby:

FIG. 1 represents the embodiment of the apparatus where the transporting fluid is injected through the tube outside the injection tube; and

FIG. 2 represents the embodiment of the apparatus where the transporting fluid is injected through the inside of the injection tube.

### DETAILED DESCRIPTION

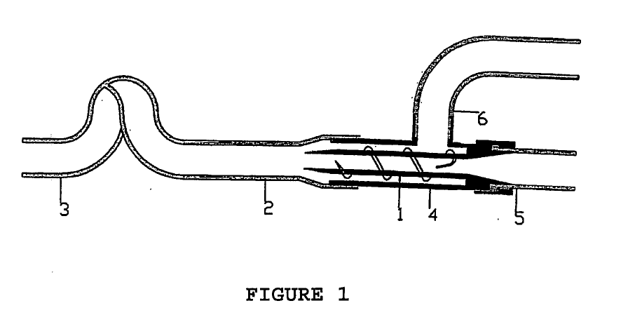

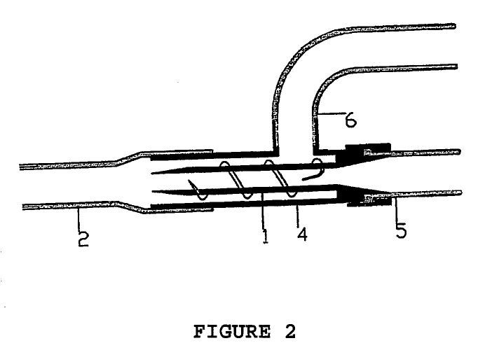

In accordance with the figures, the mixing device is comprised of a sheath (4) which surrounds the injection tube (1), said sheath being connected to a decompressor (2) and ending in a helical tube (3) coupled to the decompressor (2), said helical tube being the only fluid outlet. Attached to the injection tube (1) is a tube (5) for entry of one of the fluids, while attached to the sheath (4) is a tube (6) for entry of the second fluid. The abovementioned components can be joined to form a single part. The injection tube (1) is a rectilinear tube, with a smooth inside and the outside formed at least by a complete helical spiral whose pitch is twice the outside diameter of the tube, and its end, which constitutes around 1/10 of its total length, is slightly conical and smooth (no spiral). Its length is equal to the distance between the top end of the sheath and the part of the decompressor (2) with the largest diameter (top end of the cone of the decompressor (2)), if the transporting fluid is injected through the inside of the injection tube (1) through tube (5)—FIG. 2, or equal to the distance between the top end of the sheath (4) and the part of the decompressor (2) with the smallest diameter (bottom end of the cone of the decompressor (2)), if the transporting fluid is injected via the outside of the injection tube (1) through tube (6)—FIG. 1. The cross-section of the inside of the injection tube (1), because it is smaller than the cross-section of inlet (5), causes an increase in speed and a consequent depression in the transporting fluid when it is injected through the said inlet (5), and the area formed by the difference between the cross-section of the decompressor (2) with the smallest diameter and the cross-section of the outside of the injection tube at its end (no spiral), because it is smaller than the cross-section formed by the height of the spiral with its pitch and smaller also than the cross-section of inlet(6), causes an increase in speed and a consequent depression in the transporting fluid when it is injected through the said inlet (6). The purpose of the helical spiral is to create helical movement and force against the walls of the decompressor (2) (centrifugal force) in all the fluid that circulates outside the injection tube (1). The end of the injection tube on the outside is slightly conical and smooth (no spiral) and it has the function of stabilising and uniformising the flow of the fluid that exits the said injection tube (1). The purpose of the outflow of the fluid, with helical movement and centrifugal force, to the outside of the injection tube (1), by the action of the helical spiral, is to enable the suction fluid to be dragged inside the transporting fluid in the helical tube (3), if the transporting fluid is injected through inlet (6), thus allowing the suction fluid to be totally enveloped inside the transporting fluid, or to enable the suction fluid to be dragged outside the transporting fluid in the decompressor (2), if the transporting fluid is injected through inlet (5), thereby achieving greater agitation of the two fluids due to the conflict between the movement and rectilinear force of the transporting fluid and the helical movement and centrifugal force of the suction fluid.

The decompressor (2) is a conical tube which constitutes a nozzle with an angle of between 0° and 45°, extending from the end of the sheath (4) to a rectilinear part of length equal to or greater than the length of the sheath (4). The length of the conical part is determined by its angle. Its cross-section at the top is the same as the cross-section of the sheath (4) to which it is connected, and its cross-section at the bottom is the same as the cross-section of inlet (5). The size of the angle is determined by the expansion cone of the transporting fluid, which depends on the injection pressure when it is injected through inlet (5), so that the intersection between the said cone and the downstream extension of the cone of the decompressor occurs in the rectilinear part of the decompressor (2).

If the transporting fluid is injected through inlet (6), the size of the angle determines the area of injection pressure and the thickness of the “sleeve” of transporting fluid.

Its function is to decompress the transporting fluid, join the fluids coming from the two inlets (5) and (6) and cause the dragging of the fluid that creates suction when the transporting fluid is injected through inlet (5) with a high suction flow, due to the existence of the angle in the decompressor (2) and the high agitation that causes the fluids to mix due to the conflict between the force and rectilinear movement of the transporting fluid and the centrifugal force and helical movement of the suction fluid.

The helical tube (3) coupled to the decompressor (2) constitutes the only outlet and it is connected to the decompressor. Its cross-section must be equal to the cross-section of the outlet of the decompressor (2) and its shape is determined by the injection inlet. If the transporting fluid is injected through the inside of the injection tube (1), i.e. through tube (5), the helical tube (3) can be removed or replaced by a rectilinear tube; if the transporting fluid is injected via the outside of the injection tube (1), i.e. through tube (6), the helical tube (3) is at least a complete helicoid with the same pitch as that of the spirals around the outside of the injection tube (1). In this situation, after receiving the injection fluid with helical movement and force against the walls (centrifugal force), and inside this “sleeve” of transporting fluid the second suction fluid coming from inlet (5), its function is to mix these two fluids when they circulate through the said helical tube (3). In fact, when the two fluids (the transporting fluid which forms a “sleeve” against the walls of the tube and the second fluid which is sucked inside the said “sleeve” of transporting fluid) flow through the said helical tube (3) they meet with resistance along the bends, where they come up against obstacles that cause successive variations in speed and lead to a reduction in the centrifugal force that drove the transporting fluid, i.e. a centripetal component is created. These variations tend to convert the helical movement of the fluid at the inlet into rectilinear movement of the fluid at the outlet, and this conversion of force and movement causes the dragging of the suction fluid, with the total mixing of the two fluids.

The sheath (4) is a rectilinear tube which surrounds the injection tube (1), it is coupled to an inlet tube (6) through which the suction fluid or injection fluid enters via the outside of the injection tube (1) and it constitutes the fundamental component of the device as all the other elements are connected to it.

The tube (5) coupled to the injection tube (1) constitutes the inlet through the inside of the injection tube and it adjusts the latter tube to the sheath by means of an element which, in the embodiment represented in the figure, has an area where the converging fluid passes. Its shape can nevertheless be undifferentiated and its cross-section will have to be larger than the cross-section of the inside of the injection tube (1). Its function is to receive one of the fluids, the transporting fluid or the fluid to be dragged.

The tube (6) connected to the sheath (4) constitutes the inlet via the outside of the injection tube (1). Its shape is undifferentiated and its cross-section will have to be larger than the differential between the cross-section of the part of the decompressor (2) with the smallest diameter and the cross-section of the outside of the end of the injection tube (1) (no spiral). Its function is to receive the transporting fluid or the fluid to be dragged.

The device of this invention has two operating principles, according to the inlet used for the transporting fluid, as follows:

a) Injection of the transporting fluid via the outside of the injection tube (1) through tube (6)—FIG. 1. The transporting fluid is compressed at the end of the injection tube (1) against the wall of the decompressor (2) with the smallest diameter, where the area where the transporting fluid passes is smaller than the area formed by the height of the spiral with its pitch and smaller also than the cross-section of inlet (6), thereby increasing the injection speed. Due to the influence of the spiral around the injection tube (1), the transporting fluid acquires helical movement with force against the wall of the decompressor (2) (centrifugal force), which is stabilised and uniformised at the end of the injection tube in the part with no spiral. In the decompressor (2), the second fluid (suction fluid) is drawn inside the first fluid or transporting fluid (injection fluid), which forms a kind of “sleeve”, each fluid maintaining its relative position until reaching the helical tube (3). In this tube (3), part of the fluids varies its speed along the bends, slowing down on the longer bends in relation to the other part of the fluids, which travels more quickly and with force towards the centre of tube (3) (centripetal force) on the shorter bends, thereby causing the dragging of the suction fluid, which is compressed by the transporting fluid thus causing the two fluids to totally mix, converting the centrifugal force and helical movement of the fluids at the inlet into force and rectilinear movement at the outlet of the said helical tube (3). This is the ideal way to carry out extraction with neutralisation of pollutants coming, for example, from chimneys. The most significant example has as a transporting fluid water injected into tube (6) by means of a pump (not shown) and as a fluid to be dragged a gaseous fluid possibly loaded with pollutant elements.

b) Injection through the inside of the injection tube (1)—FIG. 2. The transporting fluid is compressed inside the injection tube and when it expands inside the decompressor (2) it forms an expansion cone which depends on the injection pressure, intercepting the suction fluid in the rectilinear part of the decompressor (2). This depends on the angle of the decompressor (2) and on the injection pressure of the transporting fluid. The force and rectilinear movement of the transporting fluid cause the dragging of the suction fluid which frictionally mixes with the first fluid (injection fluid) due to the centrifugal force and helical movement created on the outside of the injection tube (1) inside this suction fluid. This conflict between the forces and movements of the two fluids facilitates possible chemical reactions between the fluids and/or particles. It is the ideal way to naturally oxygenate water by means of forced aeration inside the apparatus. The most significant example uses water as a transporting fluid injected by means of a pump (not shown) into tube (5) and injection tube (1), and atmospheric air as a second fluid to be dragged and available through tube (6) and the outside of the injection tube (1), these fluids mixing intimately inside the rectilinear part of the decompressor (2), providing excellent oxygenation of water, for example swimming pool water.

The flow of the suction fluid increases with the flow of the injection fluid and the two increase with the increase in injection pressure.

The fluid mixing device is a technically simple piece of equipment that effectively resolves environmental problems.

The use of the characteristics of extraction with the total mixing of the suction elements by the transporting fluid makes the equipment effective in the chemical neutralization of air, together with the extraction of the pollution of a chimney.

The use of the characteristics of suction with the conflict between the force and movement of the two fluids makes the equipment ideal for aerating water and effluents. The method is efficient in the oxidation of nutrients existing in water (grease, iron, nitrates, etc.) and in the aerobic respiration of bacteria in effluents due to the high KlaV content. As aeration occurs inside the apparatus, this avoids any environmental impact in the case of the aeration of effluents.

The characteristics of high flow rate and suction force make the apparatus an alternative to its use as a vacuum pump.

The characteristics of compression and expansion of the transporting fluid with centrifugal force make it possible to directly transfer heat from one fluid to the other.

1. Device for mixing fluids of the type where a transporting fluid draws in by suction a second fluid by means of its component elements, thereby causing the two fluids to mix, characterised in that it comprises:
an injection tube (1);
a sheath (4) which surrounds the injection tube (1);
a decompressor (2) connected to the sheath (4);
an inlet tube (6) connected to the sheath (4);
an inlet tube (5) connected to the upstream end on the injection tube (1); and
a helical tube (3) connected to the decompressor (2),
the transporting fluid being injected via the outside of the injection tube through inlet tube (6) or through the inside of the injection tube through inlet tube (5).

2. Device for mixing fluids according to the previous claim, characterised in that the injection tube (1) has a smooth inside, its outside surface having at least a complete spiral extending from the inlet of tube (6) almost to the end of the said injection tube (1) with a pitch twice the outside diameter of the injection tube, the end of the said injection tube (1) constituting around 1/10 of its total length, being slightly conical and smooth.

3. Device for mixing fluids according to the previous claim, characterised in that the length of the injection tube (1) is equal to the distance between the top end of the sheath (4) and the part of the decompressor (2) with the largest diameter (top end of the cone of the decompressor), if the transporting fluid is injected through the inside of the injection tube (1) through tube (5), or equal to the distance between the top end of the sheath (4) and the part of the decompressor (2) with the smallest diameter (bottom end of the cone of the decompressor), if the transporting fluid is injected via the outside of the injection tube (1) through tube (6), said injection tube (1), when it receives the transporting fluid, causing an increase in the speed and depression thereof due to the fact that the cross-section of the inside of the injection tube (1) is smaller that the cross-section of inlet (5), if the transporting fluid is injected through this inlet (5), or due to the fact that the area formed by the difference between the cross-section of the part of the decompressor (2) with the smallest diameter (bottom end of the cone of the decompressor (2)) and the cross-section of the outside of the injection tube (1) at the part with no spiral is smaller than the cross-section of inlet (6), if the transporting fluid is injected through inlet (6).

4. Device for mixing fluids according to the previous claims, characterised in that due to the influence of the helical spiral around the outside of the injection tube (1), the fluid that circulates around the outside of the said injection tube (1) acquires helical movement towards the outlet which is stabilised and uniformised when it passes through the end of the injection tube (1) in the part with no spiral, then travels with force against the walls of the decompressor (2) (centrifugal force) causing the helical effect which forms a kind of “sleeve” which sucks in the fluid that comes from inside the injection tube (1) with rectilinear movement, the said centrifugal force also allowing the second fluid to be dragged or drawn by suction inside the transporting fluid in the said “sleeve”, in the helical tube (3) if the transporting fluid is injected through inlet tube (6) or outside the transporting fluid in the decompressor (2) if the transporting fluid is injected through inlet tube (5) where, inside the said decompressor (2), the two fluids mix with high agitation due to the conflict between the rectilinear force and movement of the transporting fluid and the helical movement of the suction fluid.

5. Device for mixing fluids according to the previous claims, characterised in that: the cross-section of the inside of the injection tube (1) defines the injection pressure level intended when the transporting fluid is injected through tube (5), whose cross-section is bigger than the outlet of the injection tube (1); and in that the area formed by the difference between the inside cross-section of the part of the cone of the decompressor (2) with the smallest diameter and the outside cross-section of the end of the injection tube (1) in the part with no spiral defines the injection pressure level intended when the transporting fluid is injected through tube (6), this difference in cross-section being smaller than the cross-section of inlet (6); this applies to both situations if the injection pump and the inlet tubes meet the pressure adjustment needs.

6. Device for mixing fluids according to claim 1, characterised in that the decompressor (2) is constituted by an initial convergent conical part with an angle of between 0° and 45°, its length being determined by the angle of the conical part, and by a rectilinear part which is an extension of the conical part of length equal to or greater than the length of the sheath (4), and in that its cross-section at the top is the same as the cross-section of the sheath (4) to which it is connected and its cross-section at the bottom is the same as the cross-section of inlet (5), and in that:
the size of the angle of the conical part is determined by the angle of the expansion cone of the transporting fluid, which depends on the injection pressure when it is injected through inlet (5), so that the intersection between the expansion cone of the transporting fluid and the downstream extension of the cone of the decompressor (2) occurs in the rectilinear part of the decompressor (2),
and if the transporting fluid is injected through inlet (6), the size of the angle determines the area of injection pressure and the thickness of the “sleeve” of transporting fluid.

7. Device for mixing fluids according to claim 1, characterised in that the helical tube (3) coupled to the decompressor (2) has at least the shape of a complete helicoid with the same pitch as that of the spiral of the injection tube (1) and a cross-section equal to the cross-section of the end of the decompressor.

8. Device for mixing fluids according to claim 1, characterised in that if the transporting fluid is injected via the outside of the injection tube (1) through inlet tube (6), the helical tube (3) coupled to the decompressor (2) receives this fluid travelling under pressure against its walls forming a helical “sleeve” (centrifugal force created outside the injection tube (1)) and inside this “sleeve” of transporting fluid the suction fluid coming from inlet (5) circulates, and part of these two fluids, when they flow through the said helical tube (3), undergo successive variations in speed along its longer bends with quicker movements directed towards the centre on its shorter bends (centripetal force), converting the helical movement of the fluid at the inlet into rectilinear movement of the fluid at the outlet, this conversion of force and movement causing the dragging of the suction fluid, with the total mixing of the two fluids.

9. Device for mixing fluids according to claim 1, characterised in that the helical tube (3) can be removed if the transporting fluid is injected through the inside of the injection tube (1).

10. Device for mixing fluids according to claim 1, characterised in that the sheath (4) surrounds the injection tube (1) and supports the whole structure of the device.

11. Device for mixing fluids according to claim 1, characterised in that the tube (5) coupled to the injection tube (1) connects the injection tube (1) to the sheath (4), has an undifferentiated shape and constitutes the inlet for the transporting fluid injected by means of a pump or for the fluid to be dragged by suction through the inside of the injection tube.

12 Device for mixing fluids according to claim 1, characterised in that the tube (6) coupled to the sheath (4) has an undifferentiated shape and constitutes the inlet for the fluid that is dragged by suction or injected via the outside of the injection tube (1).
